(19) United States
(12) Patent Application Publication
(10) Pub. No.: US 2008/0206498 A1
(43) Pub. Date: Aug. 28, 2008

(54) Shrink wrap sleeves for electronic devices

(76) Inventor: Peter Allen, Oyster Bay, NY (US)

Correspondence Address: ALFRED M. WALKER, 225 OLD COUNTRY ROAD, MELVILLE, NY, 11747-2712, US

(21) Appl. No.: 11/710,134

(22) Filed: Feb. 23, 2007

(51) Int. Cl. B65B 53/02; B29C 65/02; B65B 53/00

(52) U.S. Cl. 428/34.9; 156/84

(57) ABSTRACT

A retrofit heat-sensitive shrink wrap sleeve is placed over a tetrahedral hand-held personal electronic device to be covered, having four adjacent lateral planar sides and two remaining planar sides perpendicular to the lateral planar sides. The sleeve is aligned with the device, and then shrunk to a form fit by heating all surfaces using an ordinary hair dryer. For certain devices such as personal music/video player devices (e.g.—iPod® of Apple Corporation), the sleeve is open at top and bottom thereby providing clearance for access to connectors which are typically placed on those surfaces of the device. For other types of device such as a personal digital assistant (PDA)/camera phone device, it is more appropriate for the sleeve to be open at both sides to permit access to connectors and ports on the side. In such case, a port is provided for the camera lens of the camera phone device.

### FIELD OF THE INVENTION

The present invention relates to protecting the surfaces of personal hand-held electronic devices.

### BACKGROUND OF THE INVENTION

Handheld electronic devices are contacted with many surfaces as they are manipulated and are often stored in pockets or purses. Scratching of their surfaces is a common problem; another problem is exposure to inadvertent wetting. An inexpensive covering which will protect the surface while not interfering with the operation of the device is desired. If cost effective enough, multiple such covers can be used over the useful life of the product as the older one becomes scratched in use.

Japanese Patent application number 2000-138738 of Momoru describes a shrink wrap covering in the form of a bag with one closed end that is placed on a cell phone and shrunk to form fit by heating with a hair dryer. Similar shrink wrap protection for wireless devices is described in US Patent application 2006/0140394 of Kahl with the added option of indicia preprinted inside the shrink wrap bag. U.S. Pat. No. 5,569,511 of Spector describes a process for adding a fragrance emitting substance to shrink wrap which then would transfer to any object to which it is applied. Additionally, U.S. Pat. No. 6,139,779 of Small discloses thermochromic ink formulations suitable for transparent films. U.S. Pat. No. 5,217,307 of McClintock describes shrink wrapping a cylindrical seal over the neck and cap portion of a medicine tablet bottle to prevent tampering of the contents therein. U.S. Pat. No. 6,938,771 of Friedrich describes shrink wrapping a flower pot with a continuous truncated conical seal.

Typical transparent and translucent heat shrink plastic material is manufactured, for example, by Seal-it, Inc. of Farmingdale, N.Y., such as PVC, PET-G, OPS and PLA films.

The prior art does not describe a retrofit sleeve of a heat applied shrink sealing material, which is open at opposite ends, and is used to cover and protect tetrahedral hand-held electronic devices having four lateral sides and two opposite perpendicular sides.

### OBJECTS OF THE INVENTION

It is therefore an object of the present invention to provide a retrofit sleeve of a heat applied shrink sealing material open at opposite ends used to cover and protect a tetrahedral hand-held electronic devices.

Other objects which become apparent from the following description of the present invention.

### SUMMARY OF THE INVENTION

In keeping with these objects and others which may become apparent, the present invention is a heat-sensitive shrink wrap sleeve which is placed over the device to be covered, aligned with the device, and then shrunk to a form fit by heating all surfaces using an ordinary hair dryer. For certain devices such as personal music/video player devices (e.g.—iPod® of Apple Corporation), the sleeve is open at top and bottom thereby providing clearance for access to connectors which are typically placed on those surfaces of the device. For other types of device such as a personal digital assistant (PDA)/camera phone device, it is more appropriate for the sleeve to be open at both sides to permit access to connectors and ports on the side. Although the open ends of the shrink wrap sleeves are usually straight cut, in an alternate embodiment a contour cut such as convex shape permits better form fit at the ends of the device after shrinking.

The present invention includes a process for retrofitting a tetrahedral shaped portable handheld electronic device having four lateral planes and opposing ends substantially perpendicular to the four lateral planes, such as a portable handheld music and/or video player and/or a personal digital assistant/camera phone, with a protective sleeve covering. Two of the lateral planes are substantially parallel to each other and another pair of the lateral planes are parallel to each other, and the two pairs are perpendicular to each other of the respective pairs. The protective sleeve covering surrounds the four lateral planes of the handheld electronic device with the protective sleeve covering. Heat is applied to the protective sleeve covering with a portable heat source until the protective sleeve covering form fits about the four lateral planes. The four lateral planes may be the front, rear and two adjacent sides of the tetrahedral device, such as a handheld music/video player or the top, bottom, front and rear panels of a tetrahedral device, such as a personal digital assistant.

The present invention also includes a retrofit combination of a tetrahedral shaped portable handheld electronic device and a protective sleeve covering combination, wherein the tetrahedral shaped portable handheld electronic device has four lateral planes and opposing ends substantially perpendicular to the four lateral planes, wherein further the protective sleeve covering is retrofitted and heat shrunk to form fit about the four lateral planes of the portable handheld electronic device.

For covering devices with camera lenses, a hole must be provided over the lens in the shrink wrap sleeve to prevent distortion that would be evident if light had to pass through the transparent sleeve before entering the lens. Since the sleeves are preformed prior to this manufacturing process, the most efficient technique for providing this lens hole on only one surface should be used. Simply punching a hole would provide two holes, one on each surface. Placing a punch-stop within the sleeve during the punching process is labor intensive or machine complicated. By folding the edge of the sleeve on the centerline of the desired hole and punching a semicircle, a round hole is formed on only one surface as desired.

Typical transparent and translucent heat shrink plastic material are thermosetting materials, polymers, polymer films, such as polyethylene terephthalate (PET), PET-G, oriented polystryrene (OPS) and polylactic acid (PLA) films, and combinations thereof.

In an alternate embodiment, translucent colors in a pattern, decorative indicia, or even holographic or heat sensitive decorations activated by the warmth of a hand can be added to the interior of the heat shrink sleeve during manufacture. Also, part of the heat shrink material can be opaque and non-transparent or non-translucent, such as showing a sports logo or other visual indicia.

Using know processes (such as U.S. Pat. No. 5,569,511 of Spector), aroma emitting materials can be introduced into the shrink wrap during manufacturing that would emit a pleasant aroma after the wrap is applied to a device. This embodiment can also be combined with the previous embodiment to provide a decorated aroma-emitting wrap for an electronic device.

### BRIEF DESCRIPTION OF THE DRAWINGS

The present invention can best be understood in connection with the accompanying drawings. It is noted that the invention is not limited to the precise embodiments shown in drawings, in which:

FIG. 1 is a perspective view of the heat applied and sealed transparent protective cover of the present invention, shown with the ability of a user to manipulate the control dial, after heat-sealed installation of the cover upon a personal electronic music/video player device;

FIG. 2 is an exploded perspective view showing the vertical top to bottom direction of insertion of a personal electronic music/video player device into a transparent protective cover before application of heat sealing to the transparent protective cover;

FIG. 3 is a perspective view showing the personal electronic music/video player device already inserted into the transparent protective cover, with dimension lines shown for centering;

FIG. 3A is a perspective view of an alternate embodiment showing the use of convex edges of the cut ends of the shrink wrap;

FIG. 4 is a perspective view showing the application of heat, to seal the transparent protective cover over the personal electronic music/video player device;

FIG. 5 is an exploded front perspective view of an alternate embodiment showing the horizontal side-to-side direction of insertion of a personal digital assistant (PDA)/camera phone device into a transparent protective cover, before the application of heat to seal the transparent protective cover;

FIG. 6 is an exploded rear front perspective view of an alternate embodiment showing the horizontal side-to-side direction of insertion of a personal digital assistant (PDA)/camera phone device into a transparent protective cover before application of heat to seal the transparent protective cover; wherein the camera lens of personal digital assistant (PDA)/camera phone is exposed;

FIG. 7 is a close-up detail view of the method of forming a cut-out aperture for the camera lens of the personal digital assistant (PDA)/camera phone, by cutting an edge notch in an edge of the folded, unheated transparent protective cover, without having to punch through more than one side of the unheated transparent protective cover; wherein FIG. 7 is viewed according to the dashed circular line “7” shown in FIG. 6;

FIG. 8 is an exploded perspective view of a kit of multiple transparent protective covers used with the present invention;

FIG. 9 is a perspective view of an alternate embodiment for a translucent protective cover bearing at least one color;

FIG. 10 is a perspective view of an alternate embodiment for an aromatic aroma-emitting transparent protective cover; and,

FIG. 11 is a perspective view of an alternate embodiment for an aromatic aroma-emitting translucent protective cover, also bearing at least one color.

### DETAILED DESCRIPTION OF THE INVENTION

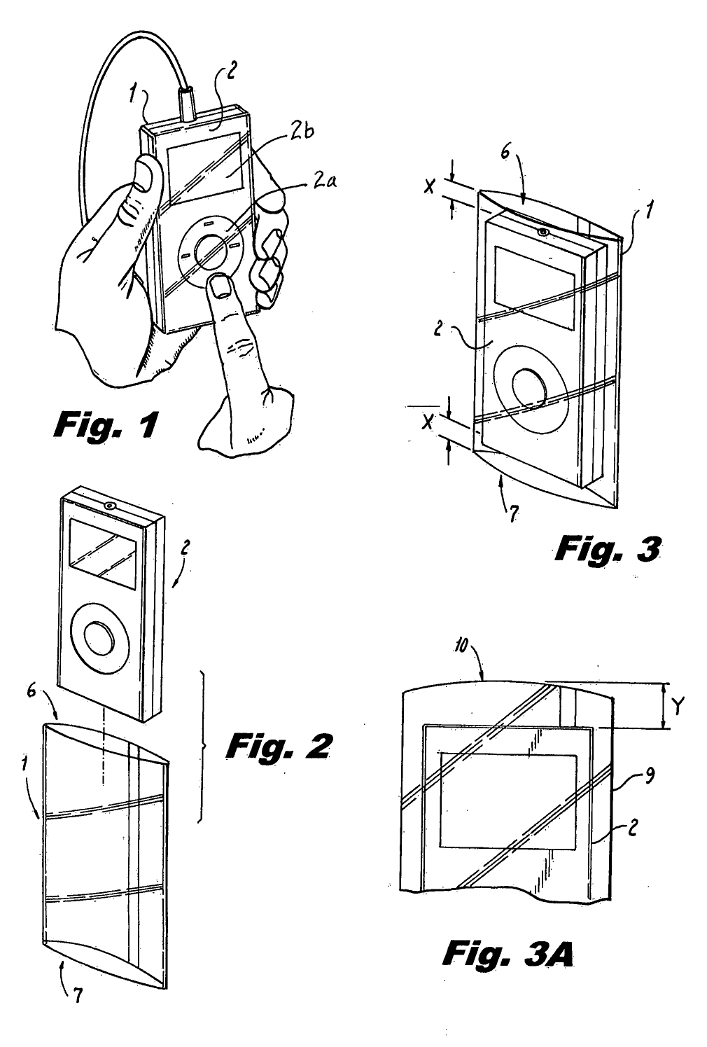

FIG. 1 shows personal music and/or video player 2 covered by a form fitted shrink wrap sleeve 1 of this invention after a successful application. FIG. 1 also shows an optional headphone cable, as it is assumed that the music/video player can be connected wirelessly also to wireless headphones. The heat applied and sealed transparent protective cover sleeve 1 is shown with the ability of a user to manipulate the control dial 2a, after heat-sealed installation of the cover sleeve 1 upon a personal electronic music/video player 2. Additionally, an optional touch sensitive viewing screen 2b can be operated through the heat applied and sealed transparent protective cover sleeve 1.

Sleeve 1 is preferably a closed rectangle, formed by two rectangular panels having sides joined by folds. Each edge is preferably parallel to each other opposite edge, and preferably perpendicular to each adjacent edge.

FIG. 2 shows the process of insertion of player 2 through open top 6 of sleeve 1 toward bottom opening 7.

FIG. 3 shows player 2 within sleeve 1 prior to the shrinking process. The central alignment of player 2 with sleeve 1 extends a pre-determined distance “X” from top opening 6 and bottom opening 7 of sleeve 1.

The alternate embodiment of FIG. 3A shows shrink wrap sleeve 9 with open top 10 and bottom 11 edges cut on a convex contour, to reduce possible minor cinching of the sleeve 9 near the edges thereof. This has been shown to create a better fit at the ends of player 2. A central alignment is provided with sleeve extensions “Y” at the top and bottom.

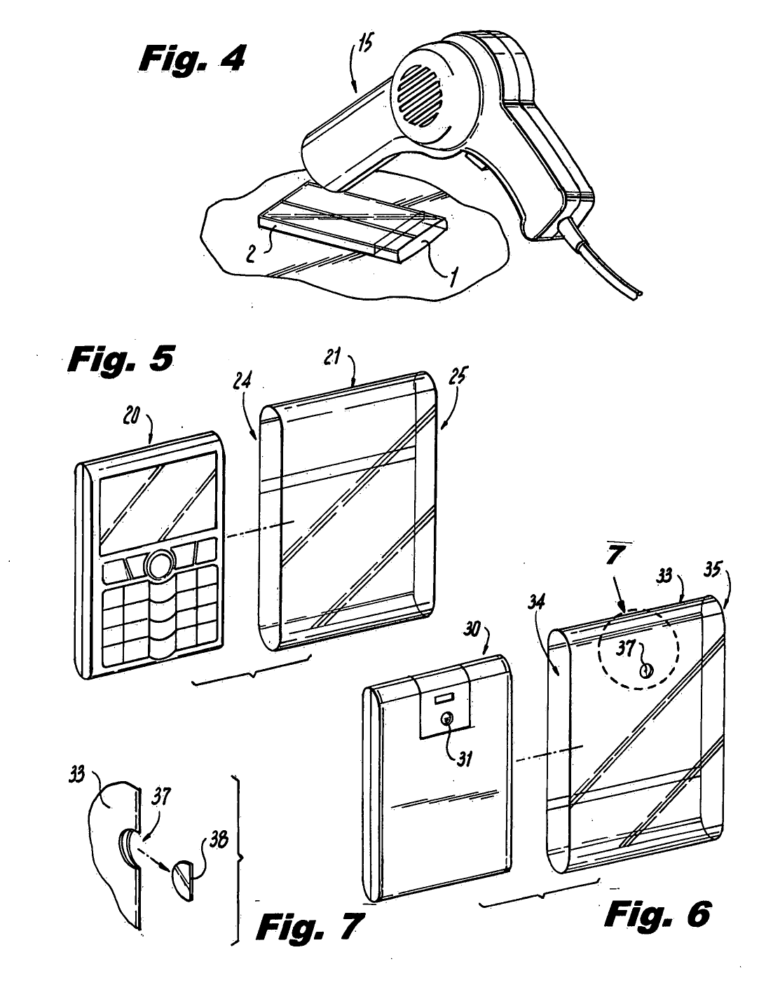

For either embodiment, the final step of heat shrinking involves the application of heat from hair dryer 15 as shown in FIG. 4.

FIG. 5 shows the side insertion of PDA 20 into sleeve 21 with side openings 24 and 25.

FIG. 6 shows a similarly shaped device 30 with camera lens 31 being inserted into sleeve 33 through opening 34 toward open side 35; with hole 37 providing clearance for unobstructed viewing through lens 31.

Hole 37 is punched during manufacture by using the technique of folding sleeve 33 and using a semicircular punch to cut hole 37 as shown in the detail of FIG. 7. Discarded folded punched section 38 is removed to form hole 37.

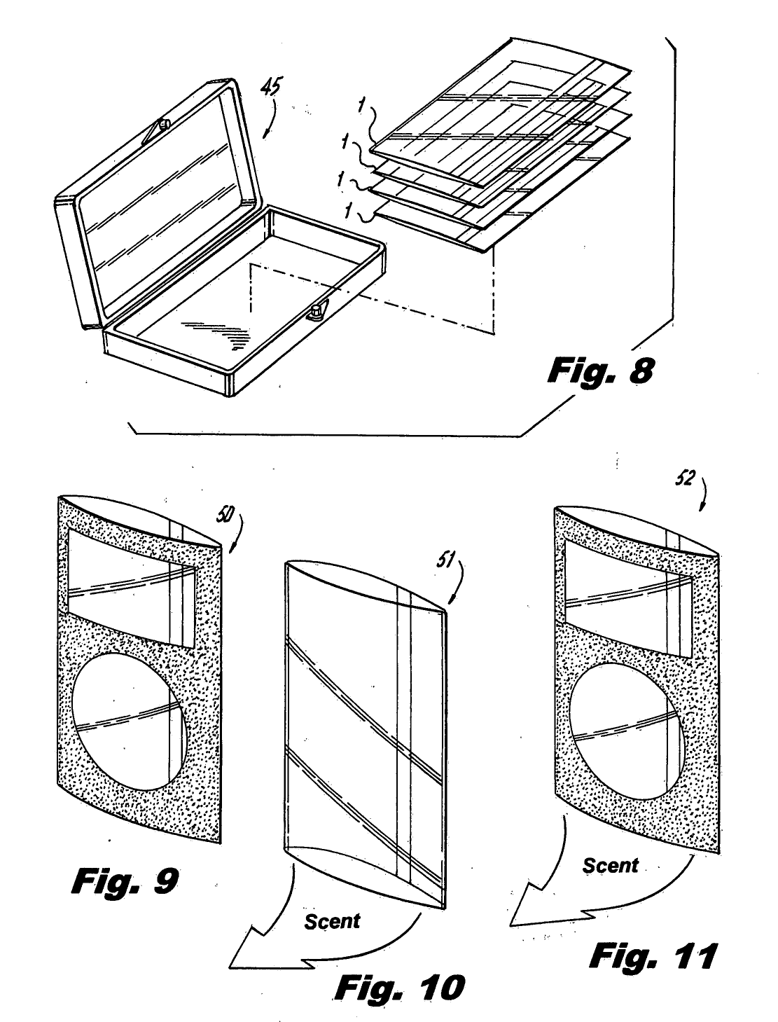

FIG. 8 shows a kit including a supply of heat shrink sleeves 1 in a convenient handy carrying case 45.

FIG. 9 shows translucent shrink wrap sleeve 50 with a pattern in at least one color. This technique of applying a pattern to the inner surface of sleeve 50 during manufacture can also be used to form decorative indicia, holographic images, or heat sensitive decoration by using heat sensitive inks.

FIG. 10 is another alternate embodiment using a transparent heat shrink sleeve 51 which has been treated during manufacturing to be aroma emitting.

FIG. 11 shows yet another embodiment combining the visual decoration with the aroma emitting feature.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing the scope of the invention, as noted in the appended Claims.

I claim:

1. A process for retrofitting a tetrahedral shaped portable handheld electronic device having four lateral planes and opposing ends substantially perpendicular to the four lateral planes, with a protective sleeve covering, comprising:
surrounding said four lateral planes of said handheld electronic device with said protective sleeve covering;
applying heat to said protective sleeve covering with a portable heat source until said protective sleeve covering form fits about said four lateral planes.

2. A tetrahedral shaped portable handheld electronic device and protective sleeve covering combination, comprising:
said tetrahedral shaped portable handheld electronic device having four lateral planes and opposing ends substantially perpendicular to said four lateral planes;
said protective sleeve covering retrofitted and heat shrunk to form fit about said four lateral planes of said portable handheld electronic device.

3. The tetrahedral shaped portable handheld electronic device and protective sleeve covering combination as in claim 2 further comprising said sleeve bearing a translucent color.

4. The tetrahedral shaped portable handheld electronic device and protective sleeve covering combination as in claim 3 further comprising said sleeve bearing a body heat touch sensitive photochromic translucent color.

5. The tetrahedral shaped portable handheld electronic device and protective sleeve covering combination as in claim 2 further comprising said sleeve bearing a holographic image.

6. The tetrahedral shaped portable handheld electronic device and protective sleeve covering combination as in claim 2 further comprising said sleeve bearing a heat sensitive ink.

7. The tetrahedral shaped portable handheld electronic device and protective sleeve covering combination as in claim 2 further comprising said sleeve bearing an aroma-emitting substance.

8. The tetrahedral shaped portable handheld electronic device and protective sleeve covering combination as in claim 2 further comprising said sleeve bearing a translucent color and an aroma-emitting substance.

9. The tetrahedral shaped portable handheld electronic device and protective sleeve covering combination as in claim 2 further comprising said device having a camera lens, said sleeve having a hole being provided over the lens in said sleeve to prevent distortion that would be evident if light had to pass through the transparent sleeve before entering the lens, said hole being provided by folding an edge of said sleeve on a centerline of said camera lens hole and punching a semicircle, wherein a round hole is formed on only one surface upon unfolding of said folded sleeve.

10. The tetrahedral shaped portable handheld electronic device and protective sleeve covering combination as in claim 2 further comprising a portion of said sleeve being opaque.

11. The tetrahedral shaped portable handheld electronic device and protective sleeve covering combination as in claim 2 wherein said sleeve is made from film formed from the group consisting of thermosetting materials, polymers, polymer films, polyethylene terephthalate (PET), PET-G, oriented polystryrene (OPS), polylactic acid (PLA) films and combinations thereof.
